(19) United States
(12) Patent Application Publication
(10) Pub. No.: US 2010/0112157 A1
(43) Pub. Date: May 6, 2010

(54) INHIBITION OF THE FORMATION OF TEA OPACIFICATION OR PRECIPITATION IN TEA DRINKS DURING STORAGE

(75) Inventors: Hongguan Xu, Shanghai (CN); Linda Ling Zhang, Shanghai (CN); Elsie Guo Chenxin, Beijing (CN)

Correspondence Address: THE COCA-COLA COMPANY;PATENT & TECHNOLOGY DEPT--NAT 19, P. O. BOX 1734, ATLANTA, GA, 30301, US

(73) Assignee: The Coca-Cola Company, Atlanta, GA (US)

(21) Appl. No.: 12/521,173

(22) PCT Filed: Dec. 26, 2007
(86) PCT No.: PCT/US07/26324

§ 371 Date: Jan. 13, 2010

(30) Foreign Application Priority Data
Dec. 30, 2006 (CN) 200610156174.2

(51) Int. Cl. A23F 3/18

(52) U.S. Cl. 426/271

(57) ABSTRACT

The present invention relates to a method for preventing, inhibiting or reducing the formation of tea opacification or precipitation in tea drinks during storage by addition of SHMP during tea drinks extraction or blending procedure. Said tea drinks are extracted from fermented tea, unfermented tea or mixture thereof.

### CROSS-REFERENCE TO RELATED APPLICATIONS

This application claims the benefit of Chinese Patent Application 200610156174.2, filed on Dec. 30, 2006.

### TECHNICAL FIELD

The present invention relates to a method for preventing, inhibiting or reducing the formation of tea opacification or precipitation in tea drinks during storage by addition of sodium hexametaphosphate (SHMP) at the optimal concentration during the production procedure.

### BACKGROUND ART

Tea drinks are one of the beverages that have recently experienced the fastest growth in the soft drinks market in China, including green tea, black tea and Oolong tea, etc. . . . Due to the natural components contained in tea and their properties, tea drinks often turn turbid and precipitate during their shelf life. There are many reasons for the appearance of precipitates. Since tea contains tea polyphenols, amino acids, etc. . . . , a complexation reaction will take place between the aforementioned components and other natural components in tea such as caffeine, proteins and polysaccharides in the presence of metal cations (especially divalent metal cations such as iron, calcium and magnesium) resulting in the precipitation which causes the formation of visible floccus (tea opacification) and thus leaving a negative impact on the quality of product appearance.

Recently, with the development of the tea drinks industry and technical improvements, great progress has been achieved to solve this problem. The major improvement lies in the manufacture techniques and strict control over water quality. SHMP has a wide range of applications as a food additive. In most cases, it has been used as a preservative or a flavouring (Qirong Jin, Chengwen Zuo, Food Science, 1991, No. 3, p 13-15). There are also reports of the usage of SHMP as a chelating agent for the prevention of tea opacification forming in tea drinks (Lian Yin, Shangxi Food Industry, 1998, No. 3, p 21-23; Yuqiong Chen et. Al., Food Science, 2000, No. 9, p 31-34). However, the effect of SHMP alone on preventing the formation of tea opacification in tea drinks, its effective concentration and the optimal addition time have not been elucidated, which limits the practical application of this technique in the prevention of tea opacification.

### DISCLOSURE OF INVENTION

The present invention provides for the identification of the effect of SHMP alone on the prevention of tea opacification formation, its effective concentration, and the optimal addition time, thereby overcoming the limitations of the prior art, and enabling the extensive application of said technique to the practical production of tea drinks, improving the appearance quality of tea drinks without affecting their flavor.

In order to solve the above technical problems, the present invention is implemented by the following technical solutions.

One embodiment of the present invention relates to a method for inhibiting the formation of tea opacification or precipitation in tea drinks during storage, comprising the addition of an effective amount of SHMP during the extraction procedure of said tea, wherein said extraction procedure refers to a period from start to end when tea is contacted with water, and said effective amount is in the range of 100 mg/l to 2000 mg/l.

Another embodiment of the present invention relates to a method for inhibiting the formation of tea opacification or precipitation in tea drinks during storage comprising the addition of an effective amount of SHMP during the production procedure of said tea drinks, wherein said production procedure comprises extracting, cooling, blending, and filling or any operating unit thereof and said effective amount of SHMP as added is in the range of 100 mg/l to 2000 mg/l.

In one embodiment of the present invention, the effective amount of SHMP is added during the blending procedure of said tea drinks.

In another embodiment of the present invention, said tea drinks are concentrated tea drinks or packaged tea drinks.

In another embodiment of the invention, said effective amount in the range of 300 mg/l to 2000 mg/l. In another embodiment of the present invention, said effective amount of SHMP as added is in the range of 400 mg/l to 1000 mg/l, preferably, of 400 mg/l to 500 mg/l. In the present invention, said SHMP is selected from the group consisting of short chain SHMP and long chain SHMP. In one embodiment of the present invention, said effective amount of SHMP as added is a long chain SHMP in the range of 100 mg/l to 2000 mg/l, particularly in the range of 300 mg/l to 500 mg/l and preferably, of 400 mg/l to 500 mg/l.

In another embodiment of the present invention said tea drinks are extracted from fermented tea, unfermented tea or a mixture thereof.

In comparison with the prior art, the advantage of the present invention is to have found out the optimal concentration of SHMP alone for inhibiting tea opacification formation thus overcoming the limitations of the said prior art, and enabling the extensive application of this technique to the practical production of tea drinks, improving the appearance quality of tea drinks without affecting their flavor.

### MODES FOR CARRYING OUT THE INVENTION

The current invention relates to providing a simple method for inhibiting opacification of tea drinks during storage. The resulting invention provides for a simple technique that improves the appearance and quality of tea drinks by inhibiting the formation of tea opacification during storage, therefore increasing the commercial success of the drinks.

The method of inhibiting opacification involves the usage of a single compound during the production process of tea drinks. In some embodiments of the present invention, the tea drinks are concentrated tea drinks or packaged tea drinks. In other embodiments of the present invention the tea drinks are extracted from fermented tea, unfermented tea or a mixture thereof.

In particular, the single compound used in the invention to inhibit opacification during storage of tea drinks is SHMP. In one embodiment of the invention, the single compound is the short chain SHMP. In another embodiment of the invention, the single compound is the long chain SHMP. Long chain SHMP appears to be more effective than the short form in inhibiting opacification.

Either form of the compound (short chain or long chain) can be used at different concentrations to achieve an inhibitory effect of the opacification. In one embodiment of the invention, the amount of the long chain SHMP used is in the range of 100 mg of SHMP per liter (100 mg/l) to 2000 mg/l, in particular 100 mg/1, 300 mg/1, 400 mg/1, 500 mg/1, 1000 mg/1, 1500 mg/l and 2000 mg/l. In one more particular embodiment of the invention, the amount of long chain SHMP used is in the range of 400 mg/l to 1000 mg/l, preferably, of 400 mg/l to 500 mg/l. In another embodiment of the invention, the amount of the short chain SHMP used is of 300 mg/l or 500 mg/l, preferably 500 mg/l.

Either form of SHMP (long chain or short chain) can be used to prevent tea opacification formation by adding the compound at different moments during the production of the drinks, which comprises the steps of extracting, cooling, blending, and filling. In one embodiment of the present invention, SHMP is added during the extraction procedure of the tea drink which refers to the period, from start to end, when tea is contacted with water. In another embodiment of the present invention, SHMP is added during the blending procedure of the tea drink. The effectiveness of SHMP in preventing tea opacification formation during storage does not seem to depend on whether the compound is added during the extraction or the blending procedures.

Effective inhibition of opacification of tea drinks by usage of SHMP can be observed at a range of different storage temperatures (4° C., 25° C., 38° C. and 55° C.). This is relevant as tea drinks, after their production has concluded, may be exposed to different temperatures during transportation of the drinks from production facilities to points of sale, and also during storage, either at their point of sale by the seller, or after sale, by the consumer. These different temperatures adversely affect the amount of opacification formed, with higher opacification observed at higher temperatures.

In comparison to the prior art, one of the advantages of the present invention is to have found out the optimal concentration of SHMP alone for inhibiting tea opacification formation, thus enabling the extensive application of this technique to the practical production of tea drinks and improving the appearance quality of tea drinks.

The following examples of the present invention provide a detailed method for inhibiting the formation of tea opacification or precipitation in tea drinks during storage. All descriptions of the present invention show that the addition of an appropriate amount of SHMP during the production procedure of tea drinks may effectively prevent the formation of tea opacification in tea drinks, which ameliorates the negative effects caused by the turbidity or precipitation, reduces quality complaints and improves product quality. Moreover, this method does not require additional equipments and is simple and easy to be applied.

### Example 1

### I Preparation of Raw Material to be Extracted and Determination of the Addition Amount of SHMP

Exactly 100 g of tea leaves (all tea leaves as raw material used in this experiment were produced in the Zhe Jiang province, China) were weighed in accordance with the proportion of a formulation and transferred into a clean glass beaker for extracting. According to the experiment protocol, 10 different concentrations of SHMP were tested based on different addition amounts of SHMP. For each concentration, SHMP was added either during the extraction or blending procedure.

The basic formulation of tea drinks is mainly composed of treated water, which is selected from the group consisting of Reverse Osmosis water or de-ionized water, green tea extract, Vitamin C (antioxidant) and Sodium bicarbonate (pH buffering agent), in order of the amount added from the most to the lest.

In addition, SHMP was precisely weighed according to the predetermined amount of SHMP to be added in the formulations (See Table 1 and Table 2).

TABLE 1
various amounts of SHMP added during the extraction

| Sample No. | 0 | 01 | 02 | 03 | 04 | 05 | 06 | 07 | 08 | 09 |
|---|---|---|---|---|---|---|---|---|---|---|
| SHMP (mg/l) | 0 | 100 | 300 | 400 | 500 | 1000 | 1500 | 2000 | 300 | 500 |

Note:
Sample 0, blank control; sodium long chain hexametaphosphate was added to samples 01 to 07; sodium short chain hexametaphosphate was added to samples 08 and 09.

TABLE 2
various amounts of SHMP added during blend procedure

| Sample No. | 0 | 01 | 02 | 03 | 04 | 05 | 06 | 07 | 08 | 09 |
|---|---|---|---|---|---|---|---|---|---|---|
| SHMP (mg/l) | 0 | 100 | 300 | 400 | 500 | 1000 | 1500 | 2000 | 300 | 500 |

Note:
Sample 0, blank control; sodium long chain hexametaphosphate was added to samples 01 to 07; sodium short chain hexametaphosphate was added to samples 08 and 09.

### II. Extraction of Tea Leave

### 1. Experiment Regarding Addition of SHMP During Extraction

1.1 3000 g of distilled water heated to 75° C. were transferred to the beaker containing tea leaves (100 g). Then, already-prepared SHMP solution was added before the beaker was placed into a water bath and kept at the same temperature (70-75° C.). This marked the starting point of the extraction procedure. The mixture was kept stirring at low speed in order to avoid extraction of soluble substance of raw materials being affected due to uneven concentration;
1.2 After 10 minutes of extracting, the extract was filtered with a 60-mesh sieve to separate tea soup from tea-leaf as soon as possible;
1.3 The filtered tea soup was transferred to a stainless steel container then put into ice-cold water to cool it down to 15° C. or lower.
1.4 After the tea soup cooled down, it was filtered with a sieve of about 100 to 200 mesh.
1.5 After having cooled down, the tea soup was centrifuged for cleaning at 5000 rpm for 15 min using a bench-top centrifuge.
1.6 Brix (Degrees Brix) and pH values of said tea soup were measured and noted after centrifugation. In total, the measurement was conducted 3 times and the three results were averaged.
   2. Experiment regarding addition of SHMP during the blending procedure: All the same as the above-description 1 except that no SHMP was added during extraction.

### III. Production of Finished Tea Drinks

1. The relevant ingredients were weighed according to the product formulation. Blending and dilution to the defined volume were performed in a stainless steel container. The required amount of SHMP was added to the samples having no SHMP added during extracting.
2. Products were cooled down to 89-90° C. rapidly after a ultra high temperature processing at 135° C. for 30 seconds and filled into 500 ml white transparent Polyethylene Terephtalate bottles. The bottles were capped, placed upside down for 30 seconds and then cooled down to room temperature immediately in ice-cold water.
3. The major physical and chemical index for the finished products obtained was measured and resulted in: Brix 0.3, pH 6.5.

### Example 2

### Comparison Results of the Various Amounts of SHMP Added During the Extraction or the Blending Procedure

The prepared samples were divided into 4 groups according to storage temperature, each temperature group was further divided into subgroups according to SHMP added, wherein 10 subgroups were used for addition during the extraction and 10 subgroups were used for addition during the blend procedure. All these samples were separately stored at 4° C./25° C./38° C./55° C. simultaneously and stood for observation.

Samples of each group were observed continuously, and any tea opacification was recorded when it was found in samples. The observation was kept for 3 months.

According to the observation results, the time of occurrence of tea opacification in each sample of each group was used as index for evaluation, and the results of samples stored at different temperatures were shown in Table 3 and discussed by comparison. The details are shown as follows.

The formation of tea opacification of each group were virtually observed, wherein the time of forming tea opacification was recorded on the exact day of the experiment, the amount of tea opacification was recorded by the following symbol: none, + slight, ++ small quantity, +++ significant quantity, ++++ large quantity

| | | | |
|---|---|---|---|
| | | Time of tea | Virtual |
| | SHMP | opacification | observation |
| samples | content | formation | amount |

Sample of group A: 4° C., refrigerated group

| | | | |
|---|---|---|---|
| 00 | 0 | none | − |
| 01 | 100 | none | − |
| 02 | 300 | none | − |
| 03 | 400 | none | − |
| 04 | 500 | none | − |
| 05 | 1000 | none | − |
| 06 | 1500 | none | − |
| 07 | 2000 | none | − |
| 08 | 300 (S) | none | − |
| 09 | 500 (S) | none | − |

Sample of group B: 25° C., room temperature control group

| | | | |
|---|---|---|---|
| 00 | 0 | Day 21 | +++ |
| 01 | 100 | Day 75 | ++ |
| 02 | 300 | Day 75 | ++ |
| 03 | 400 | none | − |
| 04 | 500 | none | − |
| 05 | 1000 | none | − |
| 06 | 1500 | none | − |
| 07 | 2000 | none | − |
| 08 | 300 (S) | Day 60 | ++ |
| 09 | 500 (S) | none | − |

Sample of group C: 38° C., accelerated test group

| | | | |
|---|---|---|---|
| 00 | 0 | Day 15 | ++++ |
| 01 | 100 | Day 21 | +++ |
| 02 | 300 | Day 50 | +++ |
| 03 | 400 | none | − |
| 04 | 500 | none | − |
| 05 | 1000 | none | − |
| 06 | 1500 | none | − |
| 07 | 2000 | none | − |
| 08 | 300 (S) | Day 21 | +++ |
| 09 | 500 (S) | none | − |

Sample of group D: 55° C., accelerated test group

| | | | |
|---|---|---|---|
| 00 | 0 | Day 3 | ++++ |
| 01 | 100 | Day 9 | ++++ |
| 02 | 300 | Day 21 | ++++ |
| 03 | 400 | Day 50 | ++ |
| 04 | 500 | Day 65 | ++ |
| 05 | 1000 | Day 50 | ++ |
| 06 | 1500 | Day 50 | ++ |
| 07 | 2000 | Day 50 | ++ |
| 08 | 300 (S) | Day 6 | ++++ |
| 09 | 500 (S) | Day 50 | +++ |

1. After 3 months of observation, no tea opacification occurred in any sample of the 4° C. group, which indicated that tea opacification would not occur under good storing conditions at low temperature even when no SHMP was added. However, this is not an ideal storing condition. In practice, it is very difficult to control the storing condition during the transportation and sales processes. Furthermore, the implementation of the ideal storing procedure would inevitably lead to an increase in sales costs.
2. The samples of the 25° C. group were used to simulate the change in actual storage procedure. The test results are shown in Table 3, wherein tea opacification occurred in samples without SHMP after being stored for 21 days; whether 100 mg/l or 300 mg/l long chain SHMP were added, tea opacification was observed in all samples on the 75^{th} day; while tea opacification occurred in samples with 300 mg/l short chain SHMP on the 60^{th} day. This indicated that that long chain SHMP was better than short chain SHMP in inhibition of tea opacification under the same storage condition and the same dosage. This conclusion was also confirmed in groups for acceleration tests. No tea opacification occurred in the three months' period in the other six samples with higher concentrations of SHMP (see Table 3). No differences were found between the groups where SHMP was added during the extraction or the blending step.
3. The 38° C. group was an acceleration test group, which was used for simulating the change of the product during storage procedure for a relatively longer period, i.e., the change of product stored for a relatively longer period was evaluated according to the observation results of different samples. The test results were shown in Table 3, wherein tea opacification was observed in samples without SHMP after the samples were stored for 15 days; tea opacification was observed in all samples with 100 mg/l long chain SHMP after 21 days; tea opacification occurred in samples with 300 mg/l long chain SHMP on the 50^{th} day; while tea opacification occurred in samples with 300 mg/l short chain SHMP on the 21^{st} day. This indicated that tea opacification occurred later in samples with long chain SHMP than that with short chain SHMP, which was very consistent with the observation results for the room temperature group. No tea opacification occurred in the three months' period in the other six samples with higher concentrations of SHMP (see Table 3). No differences were found between the groups where SHMP was added during the extraction or the blending step.
4. The 55° C. group was an acceleration test group, which was used for observing the performance of the product under an extremely severe condition, and the change of product stored for a very long period of time was also evaluated according to the observation results of different samples. The test results are shown in Table 3, wherein tea opacification was observed in samples without SHMP after the samples were stored for only 3 days; tea opacification was observed in samples with 100 mg/l long chain SHMP after 9 days; tea opacification occurred in samples with 300 mg/l long chain SHMP after 21 days; while tea opacification occurred in samples with 300 mg/l short chain SHMP on the 6^{th} day; as to the other six samples with higher concentrations of SHMP, tea opacification occurred in the samples other than the 500 mg/l sample after 50 days, and the tea opacification occurred in the sample with 500 mg/l long chain SHMP after 65 days. No differences were found between the groups where SHMP was added during the extraction or the blending step.

All the descriptions and examples in the present invention are used only for illustration purposes and incorporated herein by reference. The present invention is described in detail by the examples. Any modifications may be made thereto without departing from the spirit or scope of the invention.

1. A method for inhibiting the formation of tea opacification or precipitation in tea drinks during storage characterized in that it comprises the addition of an effective amount of SHMP during the extraction procedure of tea, wherein said extraction procedure refers to a period from start to end when tea is contacted with water and said effective amount is in the range of 300 mg/l to 2000 mg/l.

2. A method for inhibiting the formation of tea opacification or precipitation in tea drinks during storage characterized in that it comprises addition of effective amount of SHMP during the production procedure of tea drinks, wherein said production procedure comprises extracting, cooling, blending and filling or any operating unit thereof and said effective amount of SHMP as added is in the range of 300 mg/l to 2000 mg/l.

3. A method for inhibiting the formation of tea opacification or precipitation in tea drinks during storage characterized in that it comprises addition of effective amount of SHMP during the extraction procedure of tea, wherein said extraction procedure refers to a period from start to end when tea is contacted with water and said effective amount is in the range of 100 mg/l to 2000 mg/l.

4. A method for inhibiting the formation of tea opacification or precipitation in tea drinks during storage characterized in that it comprises addition of effective amount of SHMP during the production procedure of tea drinks, wherein said production procedure comprises extracting, cooling, blending and filling or any operating unit thereof and said effective amount of SHMP as added is in the range of 100 mg/l to 2000 mg/l.

5. The method according to claim 2 or 4, characterized in that said effective amount of SHMP is added during the blending procedure of said tea drinks.

6. The method according to any of claims 1 to 4, characterized in that said tea drinks are concentrated tea drinks or packaged tea drinks.

7. The method according to any of claims 1 to 4, characterized in that said effective amount of SHMP as added is in the range from 400 mg/l to 1000 mg/l.

8. The method according to claim 7, characterized in that said effective amount of SHMP as added is in the range from 400 mg/l to 500 mg/l.

9. The method according to any of claims 1 to 2, characterized in that said SHMP is selected from the group consisting of short chain SHMP and long chain SHMP.

10. The method according to any of claims 1 to 4, characterized in that said effective amount of SHMP as added is a long chain SHMP and is in the range from 300 mg/l to 500 mg/l.

11. The method according to claim 10, characterized in that said effective amount of SHMP as added is a long chain SHMP and is in the range from 400 mg/l to 500 mg/l.

12. The method according to claim any of claims 1 to 4, characterized in that said tea drinks are extracted from fermented tea, unfermented tea or mixture thereof.
